(19) United States
(12) Patent Application Publication
(10) Pub. No.: US 2010/0035469 A1
(43) Pub. Date: Feb. 11, 2010

(54) CONNECTOR

(75) Inventors: Shinichi Matsuzaki, Kanagawa (JP); Hitoshi Suzuki, Kanagawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: IRISO ELECTRONICS., LTD., Yokohama-shi, Kanagawa (JP)

(21) Appl. No.: 12/445,762

(22) PCT Filed: Jan. 9, 2007
(86) PCT No.: PCT/JP2007/050055

§ 371 Date: Apr. 16, 2009

(30) Foreign Application Priority Data
Oct. 17, 2006 (JP) 2006-283054

(51) Int. Cl. H01R 13/648

(52) U.S. Cl. 439/607.01

(57) ABSTRACT

A low-cost connector comprises a pair of first socket side shields covering two outer surfaces of a socket along a direction a terminal extends. The first socket side shield members are detachable from the socket. A pair of second socket side shield members cover two other outer surfaces of the socket in the back-and-forth direction. Thus, the outer surfaces of the socket can be covered by the second socket side shield members and the first socket side shield members according to dimensions of the terminal in the direction the terminal extends. Accordingly, if the dimensions of socket in the direction the terminal extends differ according to a number of terminals, it is easier and cheaper to manufacture shield members than to cover the socket outer surfaces by one shield member.

### BACKGROUND OF THE INVENTION

(i) Field of the Invention

The present invention relates to a connector mounted on a printed-circuit board or the like to be used for connecting a plurality of circuit boards electrically.

(ii) Description of the Related Art

Generally, as such type of connectors, a connector is known to comprise a first housing arranged on the side of a connection object, a second housing arranged on the side of the other connection object and is formed so as to be capable of fitting into the first housing, a plurality of terminals formed so as to be capable of electrically connecting the connection objects when the second housing fits into the first housing, and a shield member provided so as to cover the outer surface of the first housing (See Patent Document 1, for example).

However, with this connector, as one shield member is formed so as to cover the outer surface of the first housing, for example, when number of terminals is increased without changing intervals between terminals, the dimension of the first housing in the terminal arrangement direction will be larger. In this case, it becomes necessary to manufacture a die of the shield member anew according to the dimension thereof, therefore, it is concerned that this increases the cost of manufacturing connectors.

Patent Document 1: Japanese Patent Publication No. 2005-251461

### DISCLOSURE OF THE INVENTION

### Problems to be Solved by the Invention

The present invention was made in view of the above problems and has an object to provide a connector capable of manufacturing shield members at low cost even when many kinds of first housings with different dimensions according to number of terminals is manufactured.

### Means for Solving the Problems

In order to achieve the above object, the present invention comprises a first housing arranged on the side of a connection object, a second housing arranged on the side of the other connection object and formed so as to be capable of fitting into the first housing, a plurality of terminals formed so as to be capable of electrically connecting the connection objects when the second housing fits into the first housing, a pair of first shield members provided so as to cover two surfaces of the outer surface of the first housing respectively, the said two surfaces are along the arranged direction of terminals, the first shield members formed so as to be detachable from the first housing, and a pair of second shield members provided so as to cover the other two surfaces of the outer surface of the first housing respectively, the said other two surfaces is perpendicular to the arranged direction of the terminals.

By this, the first shield members are provided so as to cover the two surfaces of the outer surface of the first housing respectively, the said two surfaces is along the arranged direction of the terminals, the first shield members are formed so as to be detachable from the first housing, and the second shield members are provided so as to cover the other two surfaces of the outer surface of the first housing respectively, the said other two surfaces is perpendicular to the arranged direction of the terminals, therefore, even when the dimensions of the first housings in the arranged direction of terminals become different, it becomes possible to mount the first shield members according to the dimensions thereof on the two outer surfaces which are along the arranged direction of terminals.

### ADVANTAGES OF THE INVENTION

According to the present invention, the first shield members according to the dimensions in the arranged direction of the terminals can be mounted on the two outer surfaces which are along the arranged direction of terminals, therefore, the outer surfaces of the first housing can be covered without changing the dimension of the second shield members. Therefore, even though dimensions of the first housings in the arranged direction of terminals become different according to numbers of terminals, it becomes possible to manufacture shield members easier and cheaper than to cover the outer surface of the first housing by one shield member.

### BRIEF DESCRIPTION OF THE DRAWINGS

FIG. 1 is a perspective view of a socket according to an embodiment of the present invention;

FIG. 2 is a plan view of the socket;

FIG. 3 is a side view of a socket terminal;

FIG. 4 is a perspective view of a shield terminal;

FIG. 5 is a side sectional view of the socket;

FIG. 6 is a perspective view of a plug according to the embodiment of the present invention;

FIG. 7 is a plan view of the plug;

FIG. 8 is a side sectional view of the plug;

FIG. 9 is a side sectional view showing an operation when the socket and plug are fitted together;

FIG. 10 is a side sectional view showing an operation when the socket and plug are fitted together.

### DESCRIPTION OF THE SYMBOLS

1 . . . socket, 2 . . . plug, 30 . . . a plurality of socket terminals, 40 . . . a pair of the first socket side shield members, 50 . . . a pair of the second socket side shield members, 52 . . . a pair of contact pieces, 60 . . . shield terminals, 100 . . . first circuit board, 200 . . . second circuit board.

### DESCRIPTION OF THE PREFERRED EMBODIMENTS

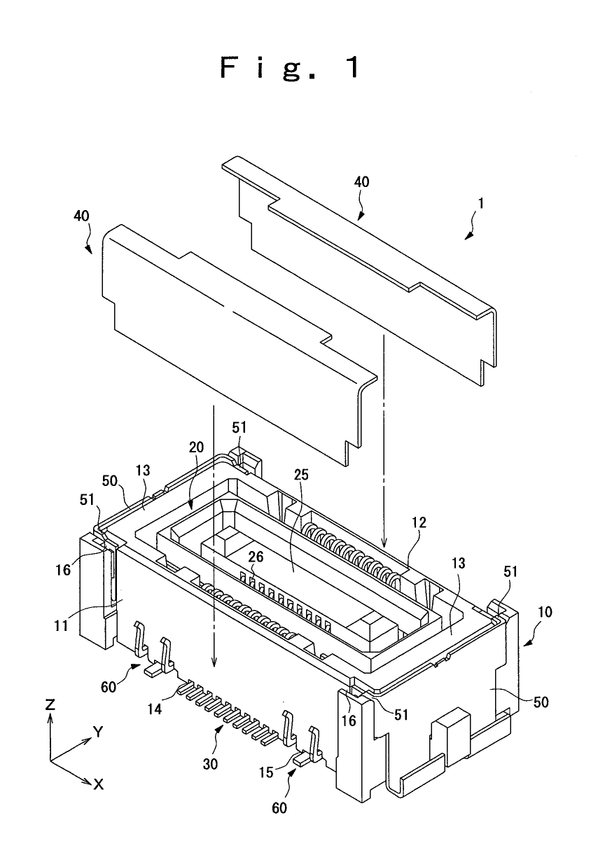

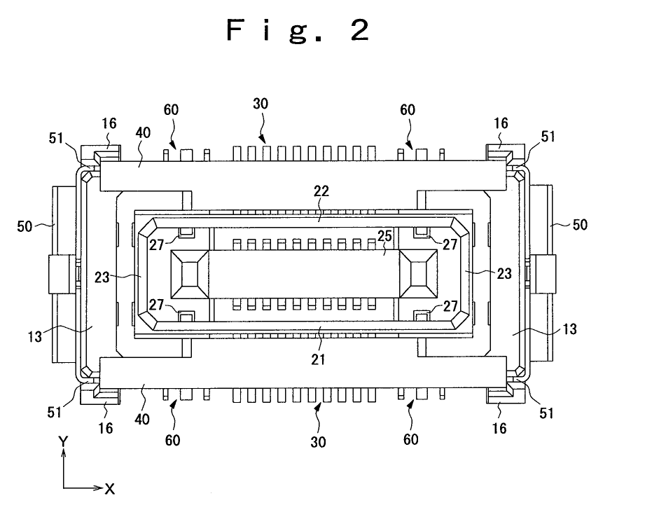

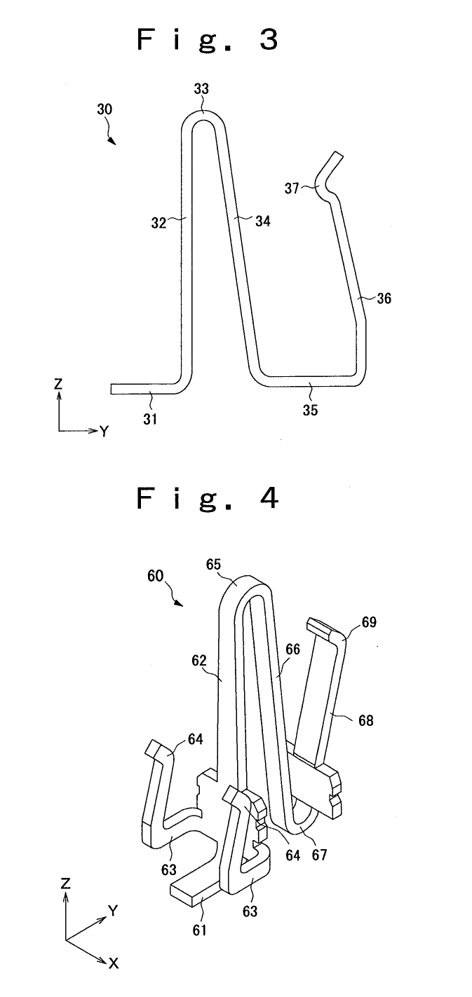

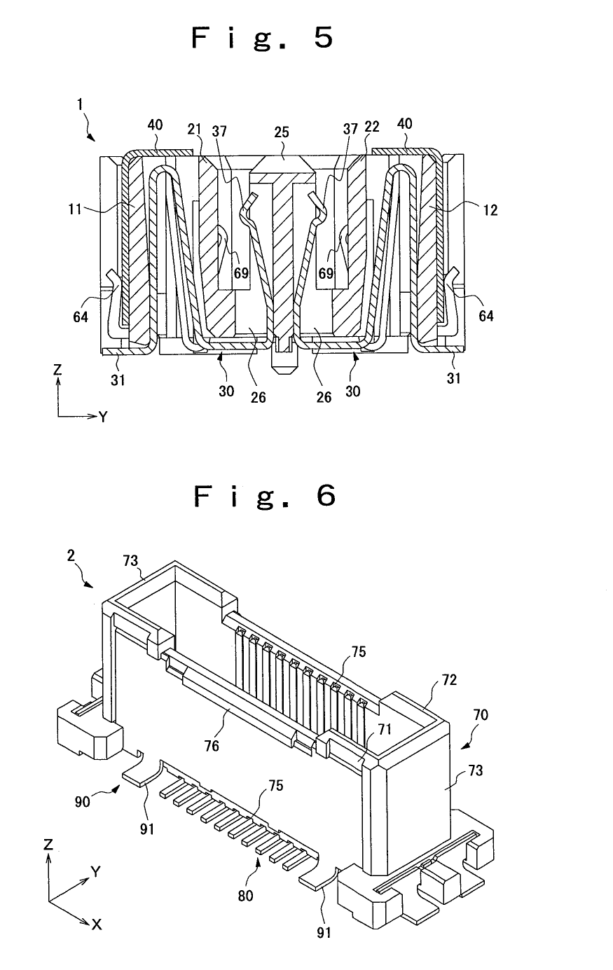

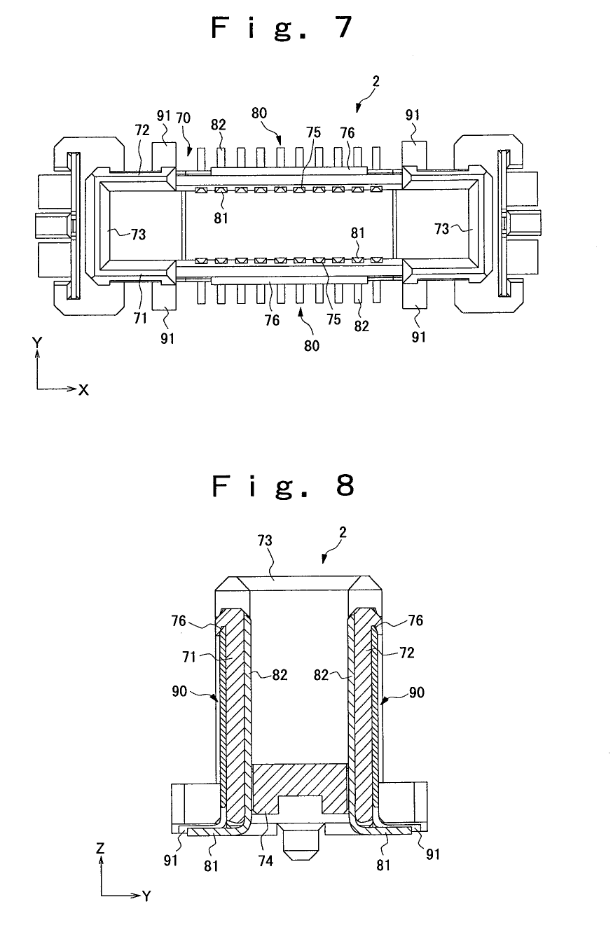

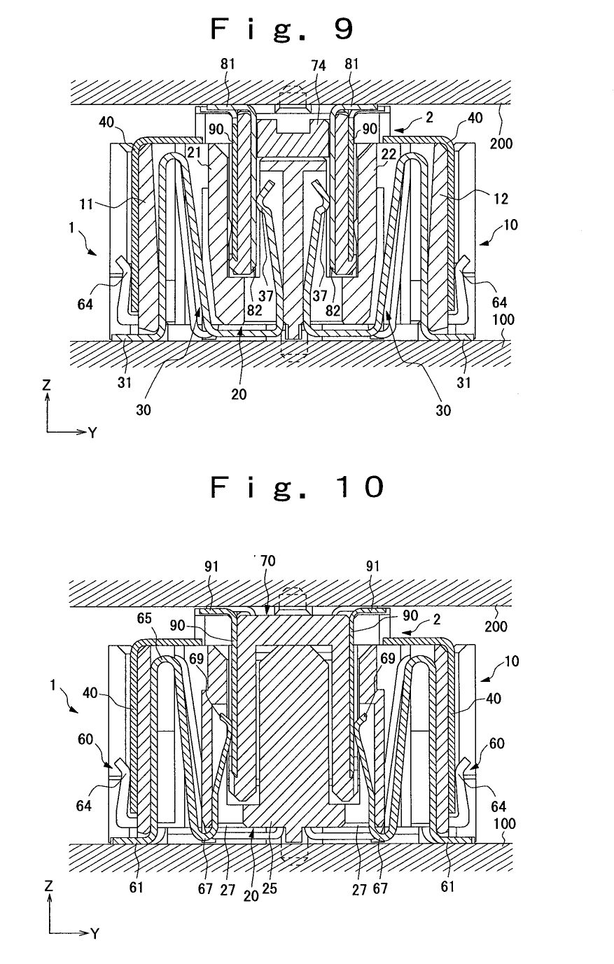

FIG. 1 to 10 show an embodiment of the present invention. FIG. 1 is a perspective view of a socket, FIG. 2 is a plan view of the socket, FIG. 3 is a side view of a socket terminal, FIG. 4 is a perspective view of a shield terminal, FIG. 5 is a side sectional view of the socket, FIG. 6 is a perspective view of a plug, FIG. 7 is a plan view of the plug, FIG. 8 is a side sectional view of the plug, FIGS. 9 and 10 are a side sectional view showing an operation when the socket and plug are fitted together.

This connector comprises a socket 1 as a first housing arranged on a first circuit board 100 as one of connection objects and a plug 2 as a second housing arranged on a second circuit board 200 as the other connection object. The plug 2 is formed so as to be capable of being fitted into the socket 1. The connector is used to connect the circuit boards 100 and 200 electrically each other.

As is shown in FIGS. 1 and 2, the socket 1 comprises a socket side fixed housing 10 which is arranged on the first circuit board 100 side, a movable housing 20 which is provided so as to be movable in the width direction (X direction in the figure) and the back-and-forth direction (Y direction in the figure) with respect to the socket side fixed housing 10, a plurality of socket terminals 30, one end of which is held by the socket side fixed housing 10 and the other end of which is held by the movable housing 20, the socket terminals 30 are formed so as to be elastic deformed in accordance with movement of the movable housing 20 with respect to the socket side fixed housing 10, a pair of first socket side shield members 40 as a first shield member which is provided so as to cover two surfaces of the outer surface of the first housing respectively, the said two surfaces are along the arranged direction of socket terminals 30, more specifically, the said two surfaces are along the width direction, a pair of second socket side shield members 50 as a second shield member which is provided so as to cover the other two surfaces of the outer surfaces of the socket side fixed housing 10 respectively, the said other two surfaces are perpendicular to the arranged direction of the socket terminals 30, in other word, the said other two surfaces are along the back-and-forth direction, and a pair of shield terminals 60 as a ground conductive members which is formed so as to be detachable from the first socket side shield members 40 respectively.

A socket side fixed housing 10 is made of a synthetic resin molding and is formed a rectangular tube shape of which the upper and bottom faces are open. More specifically, the socket side fixed housing 10 comprises a front face portion 11, a back face portion 12, and the both side face portions 13 in the width direction. On the bottom end side of the front face portion 11 and back face portion 12, a plurality of terminal holes 14 which hold one side of each socket terminal 30 is provided at even intervals with each other. Also, on the both end sides in the arranged direction of the terminal holes 14 (X direction in the figure), a pair of shield terminal holes 15 are provided so as to hold shield terminals 60 respectively. On the both end sides of the front face portion 11 and the back face portion 12 in the width direction, a mounting groove 16 is formed that the first shield members 40 are mounted from above.

A movable housing 20 is made of the synthetic resin molding and is formed to a box shape of which the upper face is open. More specifically, the movable housing 20 comprises a front face portion 21, a back face portion 22, the both side face portions 23 in the width direction, and a bottom face portion 24. A fitting portion 25 is provided at the center of the bottom face portion 24, the fitting portion 25 is formed so as to be protruded upward. Also, on a side wall portion of the front face and the back face side of the fitting portion 25, a plurality of terminal holes 26 which hold the other side of the socket terminals 30 are formed so as to penetrate through the bottom face portion 24 in the up-and-down direction (Z direction in the figure). Moreover, on the back-and-forth direction both end sides of the bottom face portion 24, a pair of through-holes 27 is formed so as to be capable of inserting the other end side of the shield terminals 60 in the up-and-down direction, the through-holes 27 are provided so as to be placed at the both end sides in the arranged direction of the socket terminals 30 respectively.

The socket terminals 30 are made of a conductive metal plate capable of being elastic deformed and arranged in a line on the both sides in the back-and-forth direction of the socket 1 respectively. As is shown in FIG. 3, the socket terminal 30 is formed so that a connection portion 31 extends in the back-and-forth direction, the connection portion 31 is to be connected to the first circuit board 100. Also, the socket terminals 30 comprises a first straight portion 32 which extends upward from the back end of the connection portion 31, a bending portion 33 which is bent downward from the upper end of the first straight portion 32, a second straight portion 34 which extends aslant downward from the bending portion 33, a third straight portion 35 which extends backward from the bottom end of the second straight portion 34, a forth straight portion 36 which extends upward from the back end of the third straight portion 35, and a contact portion 37 which is bent forward from the forth straight portion 36 and extends upward. The socket terminals 30 is capable of being elastic deformed in the width direction and back-and-forth direction with respect to the bending portion 33 as a base point.

The first socket side shield members 40 is made of a conductive metal plate which extends in the width direction of the socket side fixed housing 10 and formed so as to be detachable from the outer surfaces of the front face portion 11 and the back face portion 12 respectively. More specifically, the width direction both end sides of the first socket side shield members 40 are inserted from above into the mounting grooves 16 of the socket side fixed housing 10 respectively so that the first socket side shield members 40 is attached to cover the outer surface in the width direction of the socket side fixed housing 10. Also, the first socket side shield members 40 is formed so that the upper end side thereof covers the front face portion 11 or the back face portion 12 of the socket side fixed housing 10 and formed in approximately L-shape so as to extend to the front face portion 21 or the back face portion 22 of the movable housing 20. In this case, the upper end side of the socket side shield members 40 covers exposed parts of the socket terminals 30 between the housings 10 and 20 from above. Also, the first socket side shield members 40 can be manufactured easily by a press work of a metal plate, a dimension of which is the same with dimension of the socket side fixed housing 10 in the width direction. Therefore, it is unnecessary to manufacture dies of the first socket side shield members 40 in accordance with dimensions of the socket side fixed housing 10.

The second socket side shield members 50 is made of the conductive metal plate which extends in the back-and-forth direction of the socket side fixed housing 10 and formed so as to cover the outer surfaces of the both side face portions 13 in the width direction respectively. Also, on the both end sides in the back-and-forth direction of the second socket side shield members 50, a pair of contact pieces 51 is provided so as to respectively touch the first shield members which are provided on the front face portion 11 and the back face portion 12. The contact pieces 51 are formed by bending the back-and-forth direction two end sides of the second socket side shield members 50 toward the width direction. Also, as for the second socket side shield members 50, the dimension thereof does not change according to the number of terminals, therefore, it can be manufactured easily by using the same mold.

Shield terminals 60 are made of the conductive metal plate which is capable of being elastic deformed. As is shown in FIG. 4, a ground connect portion 61 capable of electrically connecting to a ground portion (not shown) is formed so as to extend in the back-and-forth direction, the ground portion is provided on the first circuit board 100. Also, each shield terminals 60 is provided with a first straight portion 62 which extends upward from the back end of the ground connect portion 61. On the both end sides in the width direction of the first straight portion 62, second straight portions 63 are provided respectively which extend forward from the first straight portion 62. Also, on the front end of the second straight portions 63, first shield conductive portions 64 which touches the first socket side shield members 40 is provided integrally. Moreover, each shield terminal 60 is provided with a first bending portion 65 which is bent downward from the upper end of the first straight portion 62, a third straight portion 66 which extends aslant downward from the first bending portion 65, a second bending portion 67 which is bent upward from the bottom end of the third straight portion 66, and a fourth straight portion 68 which extends aslant upward from the second bending portion 67. The shield terminals 60 are capable of being elastic deformed in the width direction and the back-and-forth direction with respect to the first and second bending portions 65 and 67 as a base point. Also, on the upper end of the fourth straight portion 68, a second shield conductive portion 69 which touches the later-described plug side shield member 90 is provided integrally.

When the socket terminals 30 are mounted on the socket side fixed housing 10, the socket terminals 30 are pressed into the terminal holes 14 from below. At this time, as is shown in FIG. 5, one end side of the socket terminals 30, in other word, the upper end side of the connect portion 31 is held by the terminal holes 14. Also, when the movable housing 20 is pressed in from above with respect to the other end side of the socket terminals 30, the fourth straight portion 36 and the contact portion 37 of the socket terminals 30 penetrate through the bottom face portion 24 of the movable housing 20 and held by terminal holes 26.

Also, when the shield terminals 60 are mounted on the socket 1, the shield terminals 60 are pressed into shield terminal holes 15 from below. At this time, the top end side of the ground connect portion 61 and the top end side of the second straight portions 63 are held by the shield terminal holes 15 and the first shield conductive portion 64 touches the first socket side shield members 40. Also, the shield terminals 60 are held in a state that the fourth straight portion 68 and the second shield conductive portion 69 penetrate upward through through-holes 27 of the movable housing 20. In this case, the outer surfaces in the width direction and back-and-forth direction of the socket side fixed housing 10 are covered by the shield members 40, 50, thus, it will be capable of reducing the effect of electromagnetic wave to the socket terminals 30 from the outside. Also, the first and the second shield conductive portions 64, 69 of the shield terminals 60 are arranged on the both end sides in the arranged direction of the socket terminals 30 so as to completely prevent the shield contact portions 64, 69 from obstructing springy deformation of the socket terminals 30.

Next, a composition of the plug 2 is explained. As is shown in FIGS. 6 and 7, the plug 2 is provided with a plug side fixed housing 70 arranged at the second circuit board 200 side, a plurality of plug terminals 80 formed so as to be held by the plug side fixed housing 70, and a pair of plug side shield members 90 formed so as to cover the outer surfaces in the width direction of the plug side fixed housing 70 respectively.

The plug side fixed housing 70 is made of the synthetic resin molding and is formed to a box shape of which the upper face is open. More specifically, the plug side fixed housing 70 comprises a front face portion 71, a back face portion 72, both side face portions 73 in the width direction, and a bottom face portion 74. The plug side fixed housing 70 is provided so as to be movable with respect to the socket side fixed housing 10 of the socket 1 and formed so as to be capable of fitting into the movable housing 20. Also, at the bottom end sides and the inner wall portions of the front face portion 71 and the back face portion 72 of the plug side fixed housing 70, a plurality of the terminal holes 75 which hold the plug terminals 80 are provided at even intervals each other respectively. Moreover, on the upper end sides of the front face portion 71 and the back face portion 72, mounting grooves 76 are formed respectively so on which the plug side shield members 90 are mounted.

The plug terminals 80 are made of the conductive metal plate and arranged in a line on the both sides in back-and-forth direction of the plug 2. As is shown in FIG. 8, the plug terminals 80 are formed so that a connect portion 81 extends in the back-and-forth direction, the connect portion 81 is to be connected to the second circuit board 200. A contact portion 82 which extends upward is provided at one end side of the connect portion 81.

Plug side shield members 90 are made of a conductive metal plate which extends in the width direction of the plug side fixed housing 70, the upper end side thereof are pressed into the mounting grooves 76 of the plug side fixed housing 70 from the below so that the plug side shield members 90 are mounted on to cover the outer surfaces of the plug side fixed housing 70 in the width direction. Also, at the bottom end side of the width direction both end sides of the plug side shield members 90, a ground connect portion 91 capable of electrically connecting to a ground portion (not shown) is formed so as to extend in the back-and-forth direction, the ground connect portion 91 is provided on the second circuit board 200.

When the plug terminals 80 are mounted on the plug side fixed housing 70, the plug terminals 80 are pressed into the terminal holes 75. At this time, as is shown in FIG. 8, the connect portion 81 and contact portion 82 of the plug terminals 80 are held by the terminal holes 75 of the plug side fixed housing 70. In this case, the width direction of the plug side fixed housing 70, in other word, the outer surfaces of the front face portion 71 and the back face portion 72 are covered by the plug side shield members 90, thus, it becomes capable of reducing the effect of electromagnetic wave to the plug terminals 80 from the outside.

The connector which is composed as above is used to connect the pair of the circuit boards 100, 200 electrically. As is shown in FIG. 9, when the plug 2 connected to the second circuit board 200 is arranged above the socket 1 connected to the first circuit board 100, and if the plug 2 is moved downward so that the plug side fixed housing 70 fits into the fitting portion 25 of the movable housing of the socket 1, the contact portion 82 of the plug terminals 80 touches the contact portion 37 of the socket terminals 30 respectively. In this case, as is shown in FIG. 10, the first shield conductive portion 64 of the shield terminals 60 touches the first socket side shield member 40, and the second shield conductive members 69 touches the plug side shield members 90. At this time, if either one of the socket side fixed housing 10 or the plug side fixed housing 70 moves in the width direction or back-and-forth direction with respect to the other, the socket terminals 30 and shield terminals 60 deform springily by the said movement and a relative positional shift of the fixed housings 10, 70 will be allowed.

Also, to change the number of the terminals 30, 80 without changing intervals between the terminals 30 and 80, it becomes necessary to make the dimensions larger in the width direction, more specifically, the terminal arranged direction of the housings 10, 20, 70. In this case, by mounting the first shield members 40 and plug side shield members 90 according to dimensions thereof on the housings 10, 70 respectively, it becomes capable of covering the shield members 40, 90 of the terminals 30, 80 respectively and reducing the effect of electromagnetic wave to the terminals 30 and 80 from the outside.

As such, according to the connector of the present embodiment, the connector comprises the socket 1 arranged on the first circuit board 100 side, the plug 2 arranged on the second circuit board 200 side and formed so as to be capable of fitting into the socket 1, a plurality of socket terminals 30 formed so as to be capable of connecting the circuit boards 100, 200 electrically when the plug 2 fits into the plug 1, the pair of the socket side shield members 40 provided so as to cover the two surfaces of the outer surfaces of the socket 1 respectively, the said two faces are along the arranged direction of the socket terminals 30 (X direction in the figure), and formed detachably from the socket 1, and the pair of the first socket side shield members 50 provided so as to cover the other two surfaces of the outer surfaces of the socket 1 respectively, the said two surfaces are along the back-and-forth direction (Y direction in the figure). Therefore, it becomes capable of mounting the first shield members 40 according to the dimensions in the terminal arranged direction thereof on the two surfaces of the outer surfaces along the arranged direction of the socket terminals 30 and covering the outer surfaces of the socket 1 without changing the dimension of the second shield members 50. Thus, even when the dimensions of the socket 1 become different due to a number of terminals, it is possible to manufacture the shield members easier and cheaper than to cover the outer surfaces of the socket 1 by one shield member.

Also, the pair of the contact portions 51 which touches the first socket side shield members 40 respectively are provided on the socket side shield members 50, thus, it becomes possible to electrically connect the shield members 40, 50 certainly.

Also, the shield terminals 60 capable of connecting electrically to the ground portion of the first circuit board 100 are detachably provided on the first socket side shield members 40, thus, it becomes unnecessary to provide a member for connecting to the ground portion on the socket side shield members 40. Therefore, it improves the flexibility of designing the first socket side shield members 40.

Moreover, the above embodiment is nothing but an example and the present invention is not limited to the above embodiment. For example, in the above embodiment, the shield terminals 60 are provided on the socket 1, however, they can be provided on the socket 2.

Also, in the above embodiment, the contact pieces 51 are provided on the second socket side shield members, however, they can be provided on the first socket side shield members.

1. A connector comprising:
a first housing arranged on a side of a first connection object;
a second housing arranged on a side of a second connection objects the second housing being capable of fitting into a first housing;
a plurality of terminals capable of electrically connecting the connection objects when a second housing fits into the first housing;
a pair of first shield members arranged to cover two surfaces of the outer surface of the first housing respectively, the said two surfaces being along the arranged direction of terminals, the first shield members being detachable from the first housing;
a pair of second shield members being a to cover the other two surfaces of the outer surface of the first housing respectively, the said other two surfaces being perpendicular to the arranged direction of the terminals.

2. The connector according to claim 1, wherein:
a contact portion which touches one of the first shield members and the second shield members is on the other shield member.

3. The connector according to claim 1, wherein:
a ground conductive member is detachable from at least one of the said first shield members and the said second shield members, the ground conductive member is capable of being electrically connected to an external ground portion.

4. The connector according to claim 2, wherein;
a ground conductive member is detachable from at least one of the said first shield members and the said second shield members, the ground conductive member is capable of being electrically connected to an external ground portion.
